(19) United States
(12) Patent Application Publication
(10) Pub. No.: US 2004/0038173 A1
(43) Pub. Date: Feb. 26, 2004

(54) Device for determining the end of the processing time of hardenable materials

(76) Inventors: Gerd Brandhorst, Landsberg (DE); Gunter Hertlein, Germering (DE); Hermann Nirschl, Ettlingen (DE); Marc Peuker, Schondorf (DE); Ingo Wagner, Worthsee (DE); Erich Wanek, Kaufering (DE)

Correspondence Address: MUETING, RAASCH & GEBHARDT, P.A., P.O. BOX 581415, MINNEAPOLIS, MN, 55458, US

(21) Appl. No.: 10/399,881

(22) PCT Filed: Oct. 11, 2001
(86) PCT No.: PCT/EP01/11767

(30) Foreign Application Priority Data
Oct. 23, 2000 (DE) 10052542.3

(51) Int. Cl. A61C 9/00

(52) U.S. Cl. 433/37; 433/32

(57) ABSTRACT

The invention relates to a measuring device which is used to determine the end of the processing time of hardenable materials, especially dental moulding materials, comprising a display unit and a sensor unit which detects a modification of at least one of the rheological properties of the material.

The invention relates to the use of a sensor for determining the end of the processing time of hardenable compounds, in particular of dental impression compounds.

To process and use impression compounds in dentistry, the directions for use normally specify appropriate times, how the impression compound is to be handled and when it is to be removed from the patient's mouth.

However, the specified times for processing and the setting behavior of the compounds are subject to various disturbing influences in dental practice, such as the temperature in the mouth at the time and room temperature at the time, the mixing energy introduced or the time spent on mixing.

It is conceivable to incorporate into the polymerizable compounds indicators which are released during the polymerization and indicate the progress of the reaction, for example by a change in the color intensity. Such an attempt is described in WO96/00560.

A disadvantage of this is that the compounds described contain a further component, which may have adverse effects on the desired properties. What is more, the color changing over time does not provide a clearly definable signal of the setting process and, moreover, requires constant visual monitoring.

DE 29 906 343 U1 attempts to solve the problem by providing a unit for dispensing multi-component compounds which is equipped with a timer to indicate a time relevant for the processing.

The unit described has the disadvantage, however, that the mixed compound is likewise subject to the external influences mentioned and consequently no clear indication is given as to when the setting process commences.

Devices with which changes of rheological properties can be sensed are known from DE 19 741 674 A1 or DE 19 903 753 A1. However, these devices are not suitable for use in dentistry for dimensional reasons alone.

It is consequently an object of the present invention to provide a device which indicates to the user the end of the processing time of hardenable or hardening compounds.

This object is achieved by the use of a sensor and by providing a suitable device, as are described in the claims.

The terms “comprise” or “include” introduce an enumeration of features which is not exhaustive. The fact that the word “a” is used in the claims before naming a feature does not rule out the possibility of the named features existing more than once, in the sense of “at least one”.

The expression end of the processing time is to be understood for the purposes of the invention as meaning the time after the expiry of which the hardenable compound has fully hardened substantially completely as intended, and substantially no changes of rheological properties can be observed and/or initiated any longer.

The expression hardenable compounds comprises all compounds which, following a polymerization reaction, for example a free-radical, cationic or anionic addition reaction and/or condensation reaction, and/or cement reaction, can change from a viscous, flowable, possibly plastically deformable state into a permanently deformed solid state.

The expression hardenable compounds preferably comprises sealing compounds and dental compounds, in particular dental impression compounds, based on polyethers, A- and C-silicones, alginates and/or polyether silicones.

In the case of impression compounds, after hardening the compound is usually in a negative form of the surface from which an impression has been taken.

Compounds of which the setting process can preferably be sensed by the device according to the invention usually have the following properties before the start of the setting process: they are pasty, highly viscous substances which, after initiation of a hardening reaction, solidify over a time period in the range from 0.1 to 60 minutes, preferably 1 to 8 minutes.

Before the start of the setting process, such compounds have, for example, a viscosity of class 0 to 3 as determined by the DIN 4823 consistency test, measured with a diameter of less than 80 mm. Materials which may be mentioned as possible examples are silicones, polyethers, epoxy resins and polyurethanes.

The Shore hardness A of the compound, measured according to DIN 53505 15 minutes after the end of the processing time, usually lies in the range from 20 to 110, preferably the range from 30 and 80.

Properties, in particular Theological properties, are to be understood as meaning all properties which, when they change, can be recorded by means of a physical and/or chemical measuring method. These include in particular the properties of dielectric constant, viscosity, compressive strength, pH, conductivity, capacitance, density and/or temperature.

The preparation of a hardenable compound comprises all forms and types of provision of the compound either by manual, mechanical or automated mixing of different components or dispensing of the compound from a container and initiation of the hardening process.

Bringing into contact is to be understood as meaning the contact of part of the surface of the hardenable compound with the surface of a substrate to which the compound has been applied, at least for the duration of the setting reaction.

The term indicating unit covers all units which are suitable for informing the user of the device of a change in state of the compound during hardening, preferably in a visual and/or acoustic form. This includes displays, in particular with LED indicators, and loudspeakers.

A sensor unit for the purposes of the invention is a unit which is suitable for sensing any change in state of the compound. This includes pH electrodes, torque transducers, oscillator crystals, thermocouples, resistance meters, capacitors, wire strain gages and ultrasonic sensors. The sensor unit may in principle be of any desired dimensions. Sensors with overall sizes of less than 5 mm are preferred.

The term surface comprises all surfaces on which the hardenable compound can be applied as intended. To be mentioned as examples are: impression trays, cup-shaped receptacles, hard organic tissue, such as tooth substance and jaw, dynamic mixers, sealing joints. Not comprised are surfaces with which the compound comes into contact during its preparation or before initiation of the actual hardening reaction.

The sensor is preferably located in a portable unit. The unit which includes the sensor can preferably be operated independently of the power supply system.

Coupling elements are intended to mean elements which allow the device to be brought into a relationship with the hardenable compound to follow the progress of the setting process in such a way that a reproducible result can be obtained.

Meant in particular are elements which permit secure fixing or fastening of the device at a defined distance from a surface or fixed in the compound applied to the surface. Suitable coupling elements comprise threads, clips, spike-shaped continuations, plug-in devices, magnets.

The invention thereby has the following advantages:

The method according to the invention, using the device according to the invention, makes it possible to follow the setting process of the compound during hardening when used as intended “in situ”, irrespective of when and how the compound was mixed.

The invention is suitable in particular in dentistry for determining the end of the processing time of dental impression compounds.

Dental compounds are usually prepared by mixing a basic paste and a catalyst paste. Depending on the mixing ratio and the substances, the setting process occurs at different rates.

The mixing of dental compounds usually takes place in a static or dynamic mixer, for example according to DE 90 17 323 U or WO 98/43727. This mixer is either fitted onto a corresponding cartridge and/or operated with an electrically operated mixing device into which cartridges can be inserted. Suitable mixing devices are described in DE 29 906 343 U1 or EP 0 422 413 A. The mixers which are used are disposable mixers, since the hardened compound cannot be removed entirely from the mixer without the mixer being destroyed.

Unlike measuring mixers or conveying devices used in the industrial sector, with sensors for monitoring the maintenance of specific Theological properties of the compound to be conveyed, the device of the present invention is distinguished by the fact that the determination of the change in a Theological property of the hardenable compound either takes place by a device which can be operated independently of the mixer and of the mixing operation or the region or portion of the device used for mixing that comes into contact with the mixed compound is formed as a disposable article.

If the compound obtained by mixing is a dental impression compound, it is preferably used to fill a dental impression tray, which is subsequently placed into the mouth cavity of a patient. After setting, the impression tray is removed from the mouth and a positive model is prepared from the impression taken. If the impression tray is removed before the end of the processing time or the end of setting, the result is unusable. If the impression tray is left too long in the patient's mouth, removal is made much more difficult. Knowing the best point in time for removal is consequently important. In addition to this, the physical and psychological strain on the patient can be reduced to the necessary minimum.

In particular when impression compounds are used to take an impression from hard organic tissue, it is important that, during the setting process and during the hardening reaction, the impression compound is not moved in the region of the surface from which the impression is to be taken, to allow a faithfully detailed impression to be ensured.

The invention consequently makes it possible to determine the end of the processing time preferably under the conditions which prevail in the patient's mouth cavity, with the consequence that the hardened compound produces an optimum impression, since it can be ensured that it is not removed before setting is at an end.

The end of the processing time of the compound can be determined for example in the following way:

To determine the progress of the setting process, the device is expediently joined to the surface to which the hardenable compound has been applied, for example of an impression tray, at the point at which the hardening compound is at its coldest. This ensures that the progress of the setting process is followed in the region of the compound that hardens last.

The device is, furthermore, preferably chemically and/or thermally sterilizable.

In a preferred embodiment, the device has a transmitter, which transmits the data sensed by the sensor unit wirelessly to a receiver unit, which is separate from the device according to the invention. This permits further miniaturization of the device on the one hand and external monitoring of the progress of the setting process on the other hand. The transmission of the data can, however, also take place in a conventional way via a connection cable.

This allows the dentist taking an impression from a row of teeth for example to follow the progress of the setting process via a portable receiving device from another consulting room. Manual monitoring by feeling the impression compound in the mouth of the patient is no longer required.

It is also conceivable for the voltage supply, the electronics and the sensor to be formed in such a way that they can be integrated in a miniaturized type of construction in the region of the surface onto which the hardenable compound has been applied, for example into an impression tray. The data transmission to the mixing unit can then take place for example by means of telemetry. In the mixing unit itself is the evaluation unit, which acoustically or optically indicates the end of the processing time of the hardenable compound.

If appropriate, the device itself also has an indicating unit, which informs the user of the progress of the setting process in an optical and/or acoustic way. It may be adequate if the indicating unit only emits a signal when a pre-settable threshold value is reached. Continuous information is also conceivable, however.

The device usually also has a switch or button, by which the measuring operation is started.

An example of a tried-and-tested sensor unit is an oscillator crystal, which generates a torsional and/or axial oscillation which is attenuated by the viscous properties of the hardening compound. The sensor head, for example in the form of a feeler, is introduced into the compound through an opening on the front side of an impression tray. The electronics and energy supply are for example exchangeably integrated, or are able to be integrated, into the impression tray.

It is also conceivable for the sensor unit to be immersed with a feeler into the compound already during mixing by a mixing unit. For example, the mixing unit or the mixer has a second flow path alongside the first flow path by which the compound is applied (bypass). The device according to the invention can be integrated into this second flow path. It is also conceivable for the device according to the invention to have a receptacle, preferably a disposable receptacle, which can be discarded after use, into which a small amount of the hardenable compound is introduced after or during mixing and before, after or during dispensing. In the receptacle there is, for example, a rotatable piston, which can be set in rotation by means of an electric drive and a drive shaft. The drive shaft is coupled, for example, to a torque transducer or a rotatable shaft, which makes it possible to determine the torque present at the rotating piston, which is proportional to the viscosity of the hardening compound. It is also possible to record the change in the torque via the current consumption of the drive.

To avoid sliding of the setting material on the rotating piston as far as possible, the surface of the rotatable piston is preferably roughened or has friction-increasing cams.

In a preferred embodiment, the aforementioned receptacle has a heater, which makes it possible to carry out the measuring operation under thermal conditions which correspond to those in the patient's mouth cavity.

Also suitable as a miniature sensor is a capacitor, the hardenable compound being introduced between the electrodes or capacitor plates. The electrode spacing is in this case constant. During the hardening of the compound, the relative dielectric constant changes and consequently so does the capacitance of the capacitor. The capacitor may be formed for example as a plate capacitor. Tube capacitors are also conceivable, however. Sensors which are based on the mode of operation of an idealized plate capacitor are known (for example system capaNCDT from Micro-Epsilon).

Preferred exemplary embodiments are explained below on the basis of the drawings.

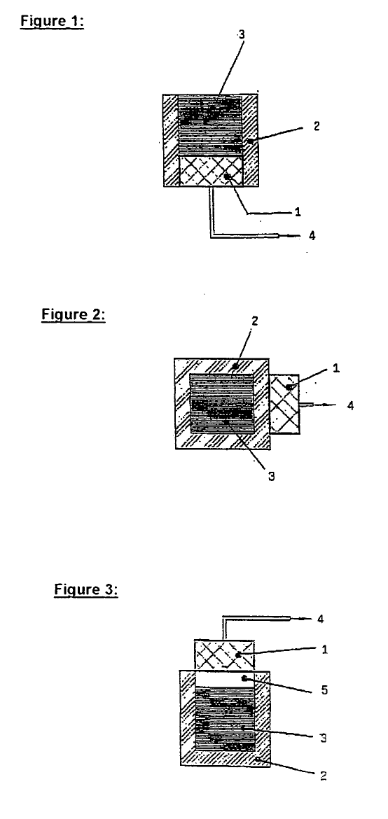

FIG. 1 shows an embodiment which uses a plate capacitor as a sensor for following the setting process.

FIGS. 2, 3 show embodiments which allow the setting process to be followed contactlessly.

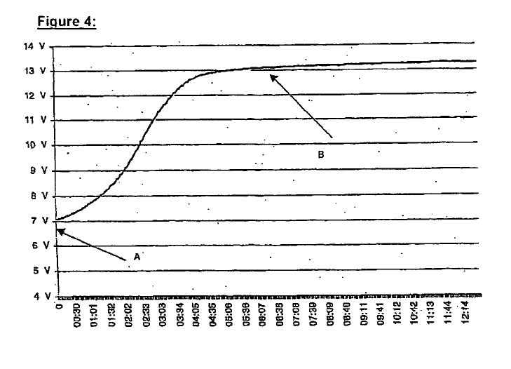

FIG. 4 shows a measuring curve, obtained by plotting the output signal of a capacitor sensor against the processing time of the hardenable compound

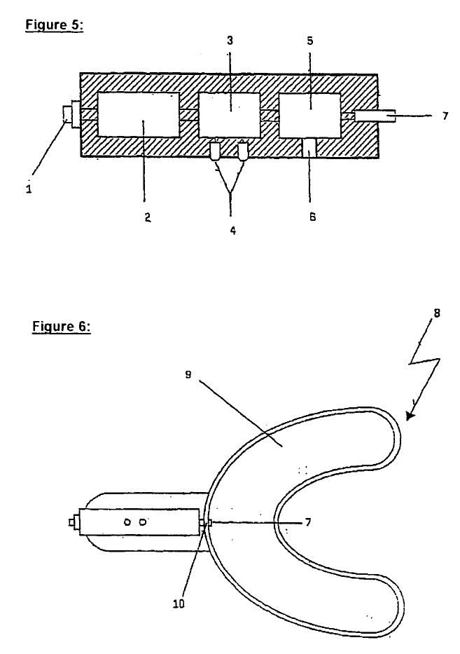

FIG. 5 shows a possible-embodiment of a portable measuring device.

FIG. 6 shows an embodiment in which the device from FIG. 5 is integrated into a dental impression tray.

In the preferred embodiment according to FIG. 1, a sleeve (2), for example made of brass, metal or plastic, is fitted over the sensor (1) in order to obtain a defined measuring volume. This is fixed by the cross section of the sensor and height of the sleeve. The measuring chamber prepared in this way is filled with the compound (3) up to the rim. The compound to be investigated consequently has a defined layer thickness (=height of the sleeve). The sleeve itself has no significant influence on the measurement, as long as it does not lie in the region of the field lines. The sensor unit is in connection with electronics via a connection (4).

In the embodiment according to FIG. 2, the setting process is followed contactlessly by means of the sensor. In this embodiment, the capacitive sensor has no direct contact with the hardenable compound. The compound (3) to be measured is located in a separate measuring chamber (2), which is produced for example from plastic. In this embodiment, the sensor (1) senses not only the compound to be measured itself but also the capacitance of the wall of the housing of the measuring chamber (2). Since the capacitance of the wall of the housing does not change during setting, the relative change in the output voltage is produced only by the change in the relative dielectric constant of the hardening compound. The method can consequently be regarded as contactless.

It is also conceivable for the measuring chamber (2) to be open and the capacitor sensor (1) to be separated from the compound to be measured only by a layer of air (5) (FIG. 3).

In FIG. 4, the output signal (volts) of the capacitive sensor is plotted as a function of the processing time (minutes). At the point in time A, the compound is still viscous, at the point in time B it has fully hardened. An initially proportionally rising output voltage which, toward the end of the processing time of the compound, asymptotically approaches a limit value is obtained. The time in which the output voltage changes by a defined value in relation to the starting value correlates with the processing time. The variation in the output voltage as a function of the processing time additionally makes it possible to make statements also about the setting characteristics of the compound measured (slope of the measuring curve).

A device for determining the end of the processing time of hardenable compounds which are brought into contact with a surface has, according to FIG. 5, for example a switch (1), a voltage supply (2), evaluation electronics (3), an optical indicator (4), activation electronics (5), a trimming potentiometer (6) and a sensor unit (7), for example an oscillator crystal or a capacitive sensor.

The device according to FIG. 5 is integrated into the tray according to FIG. 6, or attached to it. The tray (8) has a usually channel-shaped surface (9), onto which the hardenable compound is applied. In the front region of the tray there is an opening (10), via which the oscillator crystal (7) can be the immersed in the compound. The device can be coupled to the tray, for example by means of a magnet, a clip or a thread.

1. A device for following the setting process or for determining the end of the processing time of hardenable compounds which have been dispensed into a dental impression tray, comprising a voltage supply, a sensor unit and a coupling element, the sensor unit sensing at least a change in at least one property of the hardenable compound during the hardening.

2. The device as claimed in claim 1, the sensor unit being suitable for the determination of: dielectric constant, viscosity, compressive strength, pH, conductivity, capacitance, density, temperature and/or impedance.

3. The device as claimed in claim 1 or 2, the coupling element having the form of a clip, a thread, a plug-in device, a spike-shaped continuation or being magnetic, and making it possible for the device to be attached in a defined way.

4. The device as claimed in one of the preceding claims with a transmission unit, which transmits the values sensed by the sensor unit to a receiver.

5. The device as claimed in one of the preceding claims, the sensor unit being chosen from: oscillator crystal, capacitor, thermometer, pH electrode, torque transducer, thermocouple, resistance meter, wire strain gage, ultrasonic sensors.

6. The device as claimed in one of the preceding claims, it being possible for the sensor to be operated independently of the power supply system.

7. An impression tray, comprising a device as claimed in one of claims 1 to 7, the device being connected to the impression tray by means of a coupling element.

8. The impression tray as claimed in claim 7 with an opening via which the sensor unit of the device can be introduced.

9. The use of a device as. Claimed in one of claims 1 to 6 or an impression tray as claimed in claim 7 or 8 for following the progress of the setting process of dental compounds.

10. The use as claimed in claim 9, comprising the steps: a) provision of the device and an impression tray, b) filling the impression tray with a hardenable compound, c) preparation of an impression, the device according to one of claims 1 to 6 being coupled to the impression tray before or during one of the steps b) or c).

11. The use as claimed in either of claims 9 and 10, comprising step d) emission of a signal as soon as a settable threshold value is exceeded.

12. The use as claimed in one of claims 9 to 11, the end of the processing time being reached after initiation of a hardening reaction in the range from 0.1 to 60 minutes.

13. The use as claimed in one of claims 9 to 12, step c) being carried out in a temperature range from 15 to 50° C.

14. The use of a device, including a voltage supply, a sensor unit and a coupling element, in a method for following the setting process or for determining the end of the processing time of hardenable dental compounds, the sensor unit sensing at least a change in at least one property of the hardenable compound during the hardening, comprising the steps a) provision of a hardenable compound, b) bringing the hardenable compound into contact with a surface, c) sensing at least one change in at least one property of the hardenable compound which has been brought into contact with the surface during the hardening, d) emission of a signal as soon as a settable threshold value is exceeded.

15. The use as claimed in claim 14, the surface being chosen from: surface of an impression tray, of a dynamic mixer, of cup-shaped receptacles, and of hard organic tissue.
